(19) United States
(12) Patent Application Publication
(10) Pub. No.: US 2018/0167337 A1
(43) Pub. Date: Jun. 14, 2018

(54) APPLICATION OF NETWORK FLOW RULE ACTION BASED ON PACKET COUNTER

(71) Applicant: Hewlett Packard Enterprise Development LP, Houston, TX (US)

(72) Inventors: Thomas A Keaveny, Auburn, CA (US); Claudio Enrique Viquez Calderon, Heredia (CR)

(21) Appl. No.: 15/577,329

(22) PCT Filed: May 29, 2015
(86) PCT No.: PCT/US2015/033120

§ 371 Date: Nov. 27, 2017

(51) Int. Cl. H04L 12/931; H04L 12/851; H04L 12/26

(52) U.S. Cl. CPC H04L 49/35; H04L 45/64; H04L 43/16; H04L 47/2441

(57) ABSTRACT

In some examples, a network switch includes an Application-Specific Integrated Circuit (ASIC) including a Network Packet Counter (NPC), a processing resource, and a memory resource storing machine readable instructions. The instructions can, for example, cause the processing resource to assign, in accordance with instructions received by a Software-Defined Network (SDN) controller, a packet flow rule for certain packets received by the network switch to the NPC; modify, with the NPC, a value for a counter associated with the given packet flow rule for received packets that match the pattern of the given packet flow rule; and apply an action to the received packet in accordance with the flow rule only when the value for the counter is less than a threshold value.

### BACKGROUND

Computer networks can be used to allow networked devices, such as personal computers, servers, and data storage devices to exchange data. Computer networks often include intermediary datapath devices such as network switches, gateways, and routers, to flow traffic along selected datapaths for routing data between networked devices. Such datapaths can, for example, be selected by a network controller, administrator, or another entity, and can; for example, be based on network conditions, network equipment capabilities, or other factors.

### BRIEF DESCRIPTION OF DRAWINGS

FIG. 1 is a diagram of a network, according to an example.

FIG. 2 is a flowchart for a method, according to an example.

FIG. 3 is a flowchart for a method, according to another example.

FIG. 4 is a flowchart for a method, according to another example.

FIG. 5 is a flowchart for a method, according to another example.

FIG. 6 is a diagram of network switch, according to an example.

FIG. 7 is a diagram of machine-readable storage medium, according to an example.

### DETAILED DESCRIPTION

The following discussion is directed to various examples of the disclosure. Although one or more of these examples may be preferred, the examples disclosed herein should not be interpreted, or otherwise used, as limiting the scope of the disclosure, including the claims. In addition, the following description has broad application, and the discussion of any example is meant only to be descriptive of that example, and not intended to intimate that the scope of the disclosure, including the claims, is limited to that example. Throughout the present disclosure, the terms “a” and “an” are intended to denote at least one of a particular element. In addition, as used herein, the term “includes” means includes but not limited to, the term “including” means including but not limited to. The term “based on” means based at least in part on.

Software-defined networking can allow for the decoupling of traffic routing control decisions from the network's physical infrastructure. For example, in a Software-Defined Network (SDN), such traffic routing control decisions (e.g., which port of a network switch should be used to forward traffic en route to a given destination) can be determined by an entity (e.g., a network controller) that is different from the routing device itself (e.g., the network switch tasked with forwarding the traffic). A network controller used in implementing an SDN (i.e., an SDN controller) can be programmed to: (1) receive dynamic parameters of the network from intermediary datapath devices (e.g., network switches), (2) decide how to route packets over the network, and (3) inform the devices about these decisions.

In some implementations, a given network switch in an SDN can rely on flow rules stored on the switch (or otherwise accessible by the switch) for forwarding or otherwise handling traffic. Flow rules can, for example, contain information such as: (1) match fields to match against packets (e.g., an ingress port and specific packet header fields), (2) a priority value for the flow rule to allow prioritization over other flow entries, (3) counters that are updated when packets are matched, (4) instructions to modify the action set or pipeline processing, (5) timeouts indicating a maximum amount of time or idle time before a flow is expired by the switch, and (6) a cookie value which can be used by the SDN controller to filter flow statistics, flow modification, and flow deletion.

Certain implementations of the present disclosure are directed to the use of an Application Specific Integrated Circuit (ASIC) of a network switch to apply actions associated with a given flow rule to a user-defined (or other predetermined) number of packets matching the flow. For example, instead of the network switch forwarding every packet with a particular Media Access Control (MAC) destination address (DA) to a given port as defined by an associated flow rule, the network switch may be instructed to send just the first five matching packets to the port. As described further herein, such functionality is not limited to forwarding packets and can, for example, include modification of packets (such as modification of packet header and/or payload), copying of packets, etc.

Certain implementations of the present disclosure can be used to improve various network applications, such as certain applications related to network tapping, network monitoring, management, deep packet inspection, etc. For example, certain existing Deep Packet Inspection are designed to extract data from each packet that matches a flow rule to determine which actions to execute. In some circumstances, such applications can use an unduly large amount of central processing unit (CPU) processing (and/or other switch resources and can tend to create network traffic bottlenecks. However, the use of certain implementations of the present disclosure can allow for improved traffic sampling and greater granularity in terms of quantity of packets that are processed. That is, only certain traffic types may be selected in order to reduce the volume of traffic sent to sampling applications. Other advantages of implementations presented herein will be apparent upon review of the description and figures.

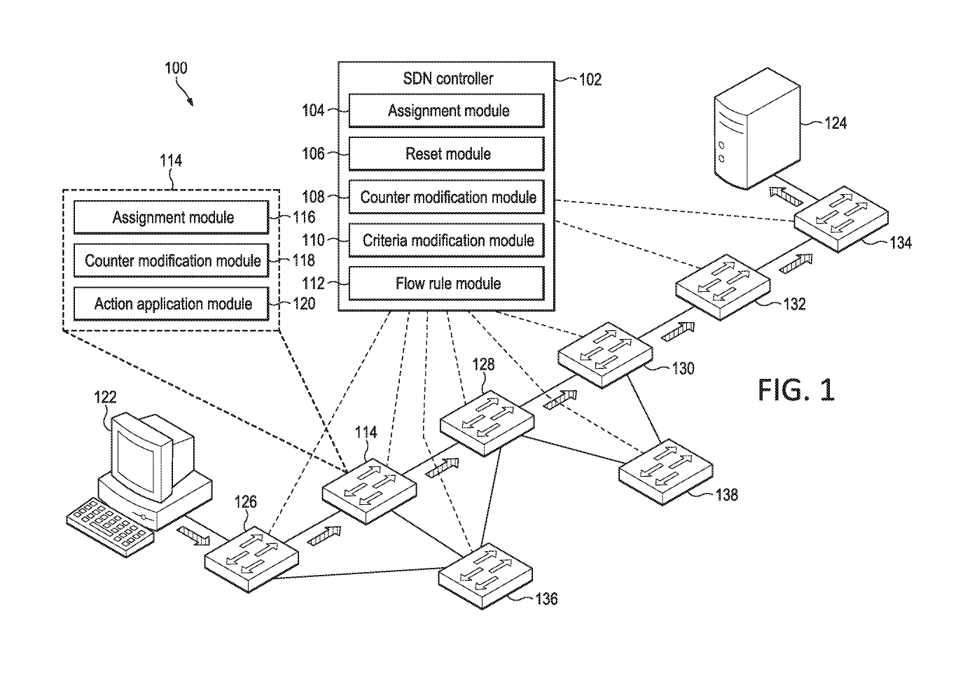

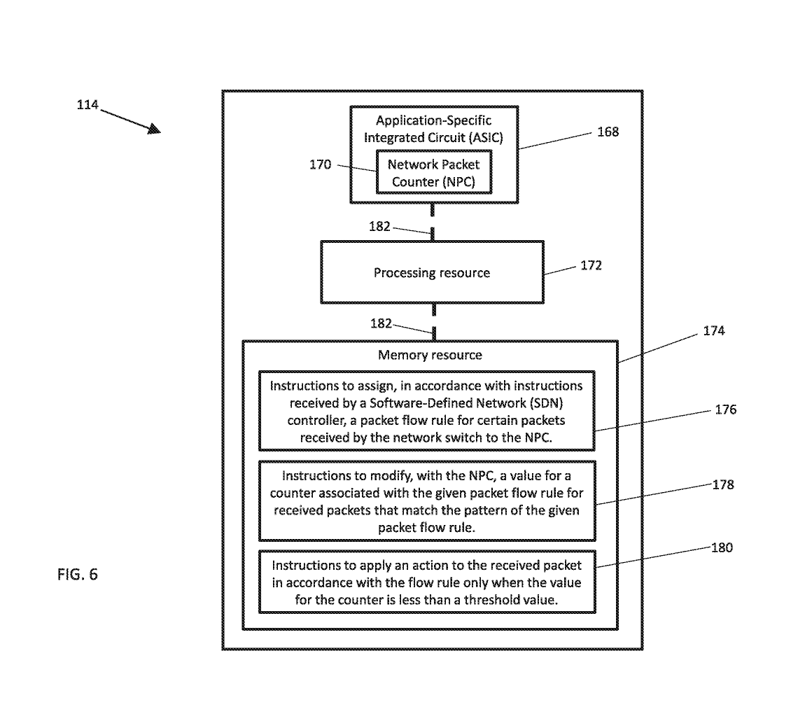

FIG. 1 is a diagram of an example software-defined network (SDN) 100 including an example SDN controller 102 including various combined hardware and software modules 104, 106, 108, 110, and 112 as well as an example network switch 114 having various combined hardware and software modules 116, 118, and 120. The structure and functionality of the various modules of SDN controller 102 and network switch 114 are described in detail below with respect to FIG. 6. FIG. 1 depicts traffic along a datapath between an example source node 122 and example destination node 124, the datapath being defined by network nodes 126, 114, 128, 130, 132, and 134. Other network nodes, such as nodes 136 and 138 can be included within SDN 100 but are not used for in this datapath. It is appreciated that the datapath can be determined by SDN controller 102 based on one or more static parameters, such as link speeds and number hops between the nodes and can further (or alternatively) be based on one or more dynamic parameters, such as Quality of Service (QoS), network latency, network throughput, network power consumption, etc.

As provided above, network nodes within SDN 100 can forward traffic along the datapath based on metadata within the traffic. For example, traffic in the form of a packet can be received at network switch 114 (or another suitable intermediary network node). For consistency, the industry term “packet” is used throughout this description, however, it is appreciated that the term “packet” as used herein can refer to any suitable protocol data unit (PDU). Such a packet can, for example, include payload data as well as metadata in the form of control data. Control data can, for example, provide data to assist the network node with reliably delivering the payload data. For example, control data can include network addresses for source node 122 and destination node 124, error detection codes, sequencing information, packet size of the packet, a time-to-live (TTL) value, etc. In contrast, payload data can include data carried on behalf of an application for use by source node 122 and destination node 124.

As provided above, in an SDN (such as for example SDN 100), control decisions for routing traffic through the network can be decoupled from the network's physical infrastructure. For example, SDN controller 102 can be used to instruct network nodes to flow traffic along a selected routing path defined by the nodes. In some implementations, these nodes can, for example, be in the form of network switches or other intermediary network devices. The use of such software-defined networking can provide other functionality. For example, one or more applications can be installed on or interface with SDN controller 102 to meet customer use cases, such as to achieve a desired throughput (or another QoS) over SDN 100, enforce security provisions for SDN 100, or provide another suitable service or functionality.

The functionality of SDN controller 102 can, for example, be implemented in part via a software program on a standalone machine, such as a standalone server. In some implementations, SDN controller 102 can be implemented on multi-purpose machines, such as a suitable desktop computer, laptop, tablet, or the like. In some implementations, SDN controller 102 can be implemented on a suitable non-host network node, such as certain types of network switches. It is appreciated that the functionality of SDN controller 102 may be split among multiple controllers or other devices. For example, SDN 100 is described and illustrated as including only one SDN controller 102. However, it is appreciated that the disclosure herein can be implemented in SDNs with multiple controllers. For example, in some SDNs, network devices are in communication with multiple controllers such that control of the network can be smoothly handed over from a first controller to a second controller if a first controller fails or is otherwise out of operation. As another example, multiple controllers can work together to concurrently control certain SDNs. In such SDNs, a first controller can, for example, control certain network devices while a second controller can control other network devices. In view of the above, reference in this application to a single SDN controller 102 that controls the operation of SDN 100 is intended to include such multiple controller configurations (and other suitable multiple controller configurations).

Source node 122 and destination node 124 can, for example, be in the form of network hosts or other types of network nodes. For example, one or both of source node 122 and destination node 124 can be in the form of suitable servers, desktop computers, laptops, printers, etc. As but one example, source node 122 can be in the form of a desktop computer including a monitor for presenting information to an operator and a keyboard and mouse for receiving input from an operator, and destination node 124 can be in the form of a standalone storage server appliance, it is appreciated that source node 122 and destination node 124 can be endpoint nodes on SDN 100, intermediate nodes between endpoint nodes, or positioned at other logical or physical locations within SDN 100.

The various intermediary nodes within SDN 100 can, for example, be in the form of switches or other multi-port network bridges that process and forward data at the data link layer. In some implementations, one or more of the nodes can be in the form of multilayer switches that operate at multiple layers of the Open Systems Connection (OSI) model (e.g., the data link and network layers). Although the term “network switch” is used throughout this description, it is appreciated that this term can refer broadly to other suitable network data forwarding devices. For example, a general purpose computer can include suitable hardware and machine-readable instructions that allow the computer to function as a network switch. It is appreciated that the term “switch” can include other network datapath elements in the form of suitable routers, gateways and other devices that provide switch-like functionality for SDN 100.

The various nodes within SDN 100 are connected via one or more data channels, which can, for example be in the form of data cables or wireless data channels. Although a single link (i.e., a single line in FIG. 1) between each network node is illustrated, it is appreciated that each single link may include multiple wires or other wired or wireless data channels. Moreover, FIG. 1 further depicts SDN controller 102 as being connected to each network nodes via broken lines, which is intended to illustrate control channels between SDN controller 102 and respective nodes. However, it is appreciated that SDN controller 102 may be directly connected to only one or a few network nodes, while being indirectly connected to other nodes of SDN 100. As but one example, SDN controller 102 can be directly connected to node 128 via an Ethernet cable, while being indirectly connected to node 130 (e.g., by relying on node 128 as an intermediary for communication with node 130).

Within the context of an SDN, controlled network nodes can be used as sensors in the network as they have information about dynamic network parameters. When polled via standard SDN interfaces the devices can report this information to the SDN controller. SDN 100 can, for example, be implemented through the use of SDN controller 102 that interfaces with various SDN-compatible devices via a suitable Application Program Interface (“API”), or another suitable protocol (e.g., OpenFlow). In some implementations, SDN controller 102 may interface with controlled network devices via an interface channel that connects each controlled device to SDN controller 102 to allow SDN controller 102 to configure and manage each device, receive events from each device, and send packets using each device.

As used herein, the term “controlled” and similar terminology in the context of SDN-compatible network nodes, such as “controlled switches,” is intended to include devices within the control domain of SDN controller 102 or otherwise controllable by SDN controller 102. Such a controlled node can, for example, communicate with SDN controller 102 and SDN controller 102 is able to manage the node in accordance with an SDN protocol, such as the OpenFlow protocol. For example, an OpenFlow-compatible switch controlled by SDN controller 102 can permit SDN controller 102 to add, update, and delete flow entries in flow tables of the switch using suitable SDN commands.

In the example SDN 100 depicted in FIG. 1, the various network nodes are in the form of intermediary nodes (e.g., controlled network switch 114) and host devices (source node 122 and destination node 124). It is appreciated however, that the implementations described herein can be used or adapted for networks including more or fewer devices, different types of devices, and different network arrangements. It is further appreciated that the disclosure herein can apply to suitable SDNs (e.g., certain hybrid or heterogeneous SDNS) in which some devices are controlled by an SDN controller (e.g., SDN controller 102) and some devices are not controlled by the SDN controller (e.g., SDN controller 102 or any other SDN controller 102). For example, in some implementations, at least one node (e.g., node 114) along a given datapath is controlled by SDN controller 102 and at least one node along the given datapath (node 128) is not controlled by SDN controller 102.

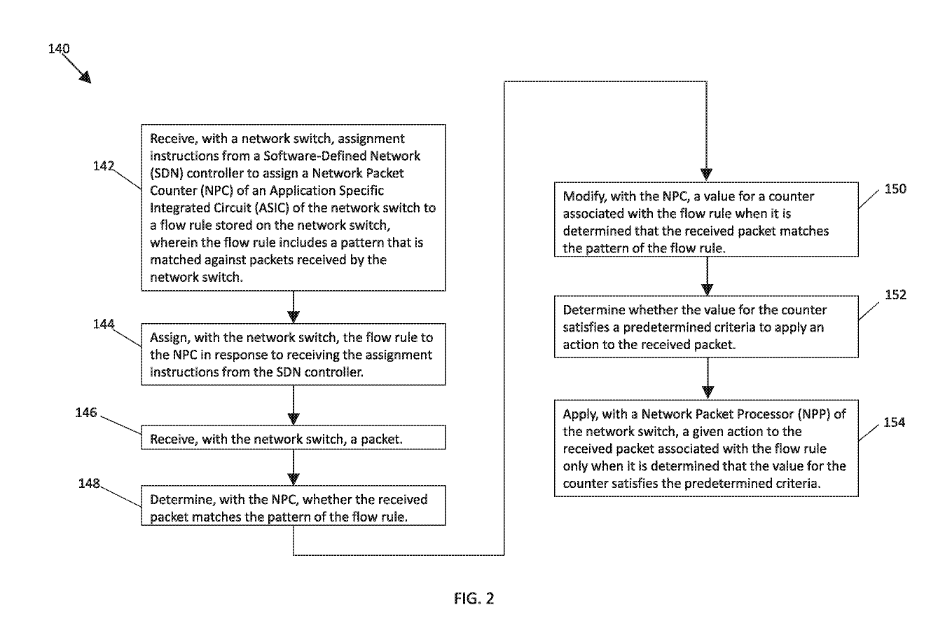

FIG. 2 illustrates a flowchart for a method 140 according to an example of the present disclosure. For illustration, the description of method 140 and its component steps make reference to example SDN 100 and elements thereof, such as for example SDN controller 102, network switch 114, source node 122, destination node 124, etc., however, it is appreciated that method 140 or aspects thereof can be used or otherwise applicable for any suitable network or network element described herein or otherwise. For example, method 140 can be applied to computer networks with different network topologies than those illustrated in FIG. 1.

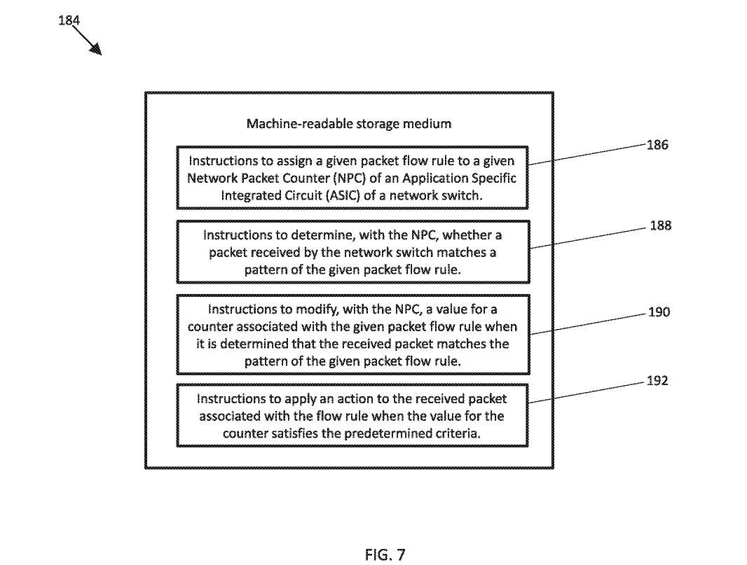

In some implementations, method 140 can be implemented in the form of executable instructions stored on a memory resource (e.g., the memory resource of the network switch of FIG. 6), executable machine readable instructions stored on a storage medium (e.g., the medium of FIG. 7), in the form of electronic circuitry (e.g., on an Application-Specific integrated Circuit (ASIC)), and/or another suitable form. Although the description of method 140 herein primarily refers to steps performed on network switch 114 for purposes of illustration, it is appreciated that in some implementations, method 140 can be executed on another computing device within SDN 100 or in data communication with network switch 114.

Method 140 includes receiving (at block 142), with network switch 114, assignment instructions from SDN controller 102 to assign a Network Packet Counter (NPC) of an ASIC of network switch 114 to a flow rule stored on network switch 114. Method 140 further includes a related block (block 144) in which network switch 114 assigns the flow rule to the NPC in response to receiving the assignment instructions by SDN controller 102. The flow rule can, for example, include a pattern that is matched against packets received by the network switch. For example, as described above, a given flow rule can, for example, contain information such as match fields to match against packets (e.g., an ingress port and specific packet header fields) as well as instructions to modify the action set or pipeline processing. As a simple example, a first flow rule for network switch 114 can provide that any packets received through ingress port A are to be forwarded to egress port C and a second flow rule for network switch 114 can provide that any packets received through ingress port B are to be forwarded to egress port D. In accordance with block 144, an example set of assignment instructions can assign the first flow rule to the NPC so that any packet that matches the first flow rule is further processed and/or analyzed by the NPC.

Method 140 includes receiving (at block 146) a packet with network switch 114. As provided above, such a packet can, for example, include payload data as well as metadata in the form of control data. Control data can, for example, provide data to assist the network node with reliably delivering the payload data. In the example SDN 100 of FIG. 1, network switch 114 can receive the packet from node 126.

Method 140 includes determining (at block 148), with the NPC, whether the received packet matches the pattern of the flow rule. The NPC can be a portion of the ASIC designed to allow for efficient and quick network packet counting, rather than general-purpose processing. The NPC can, for example, store the pattern of the flow rule and can thereafter quickly determine whether the received packet matches the pattern. It is appreciated that the term “ASIC” as used herein can, for example, include related technologies such as application-specific field-programmable gate arrays (FPGAs), which can, for example contain an array of programmable logic blocks, and a hierarchy of reconfigurable interconnects that allow the blocks to be wired together. Suitable ASICs for use with the present disclosure can, for example, allow for logic blocks to be configured to perform complex combinational functions as well as simple logic gates like AND and XOR. Suitable ASICs for use with the present disclosure can, for example, also include memory elements, which may be simple flip-flops or more complete blocks of memory.

Method 140 includes modifying (at block 150), with the NPC, a value for a counter associated with the flow rule when it is determined that the received packet matches the pattern of the flow rule. In some implementations, modifying the value for the counter includes incrementing the value for the counter. However, it is appreciated that other modifications may be applied. For example, in some implementations the NPC may increase the counter value by two units. Likewise, non-linear modifications can be made, such as for example multiplying the counter value. Moreover, it is further appreciated that the NPC can, in some implementations, reduce the counter value and/or reset the counter value to 0. It is further appreciated that in some implementations, the NPC may count data (or another aspect) associated with matching packets and does not actually count the packets themselves. For example, in some implementations, the NPC can count a predetermined amount of data received in matching packets (e.g., 10,000 bytes of data in matching packets) before applying an action. It is appreciated that other criteria besides a number of packets, data, etc., can be counted by the NPC in certain implementations.

Method 140 includes determining (at block 152) whether the value for the counter satisfies a predetermined criteria to apply an action to the received packet. In some implementations, the predetermined criteria is satisfied when the value for the counter is less than a threshold value and the predetermined criteria is not satisfied when the value for the counter is equal to or exceeds a threshold value. In some implementations, the predetermined criteria is satisfied when the value for the counter is less or equal to a threshold value and the predetermined criteria is not satisfied when the value for the counter exceeds a threshold value. Such a threshold value can, for example, correspond to a number of packets received by network switch 114, such as for example five packets. It is appreciated that more complicated criteria can be applied. For example, in some implementations the criteria is satisfied only if the value for the counter is less than a threshold value and another condition is satisfied, such as a certain amount of time has elapsed since a starting time. It is appreciated that other types of conditions and criteria may be used. For example, in some implementations, the condition can be in the form of an amount of data, such as a given number of bytes of data from matching packets. For example, criteria may be satisfied when 10,000 bytes of data from matching packets is received by the network switch. In such an implementation, if each matching packet has a size of 1,000 bytes, then the criteria can be satisfied after the switch receives 10 matching packets. As described in further detail below, the criteria can be determined by SDN controller 102 by itself or in combination with network switch 114 or another entity, such as a network administrator.

Method 140 includes applying (at block 154), with a Network Packet Processor (NPP) of the network switch, a given action to the received packet associated with the flow rule only when it is determined that the value for the counter satisfies the predetermined criteria. In the simple example described above, the action associated with the flow rule can be to forward to egress port C any packet received through ingress port A. That is, in some implementations, the action applied at block 154 is to send the received packet to a given port of network switch 114. However, it is appreciated that additional or alternative actions can be applied at block 154. For example, in some implementations, the action associated with the flow rule can be to modify a received packet, such as for example by changing header information of the packet. Likewise, in some implementations, the action associated with the flow rule can be to create a copy of the received packet. It is appreciated that any suitable SDN associated with the flow rule (e.g., one or more actions according to OpenFlow specifications) can be applied at block 154. In some implementations, actions can be applied for a predefined amount of time (e.g., by associating timers to the action) or a predefined number of bytes (e.g., by associating bytes counters to the action), and/or other conditions.

In some implementations, applying (at block 154) a given action to the packet can, for example, include applying a series of given actions to the packet. That is, a first action can be applied first to the packet by NPP and a second action can then be applied to the packet. In some implementations, an alternative action is applied to the received packet when it is determined that the value for the counter does not satisfy the predetermined criteria. For example, method 140 can include applying a first action (e.g., forwarding the packet through egress port C) when the counter value is less than five and applying a second action (e.g., forwarding the packet through egress port D) when the counter value is equal to or exceeds five. This example is provided solely for illustration and it is appreciated that any suitable SDN action can be applied, including no action (e.g., dropping the packet), when it is determined that the value for the counter does not satisfy the predetermined criteria. For example, in some implementations, if the value for the counter does not satisfy the predetermined criteria, then a default of “no action” may be taken.

Although the flowchart of FIG. 2 shows a specific order of performance, it is appreciated that this order may be rearranged into another suitable order, may be executed concurrently or with partial concurrence, or a combination thereof. Likewise, suitable additional and/or comparable steps may be added to method 140 or other methods described herein in order to achieve the same or comparable functionality. In some implementations, one or more steps are omitted. For example, in some implementations, block 142 of receiving assignment instructions from SDN controller 102 can be omitted from method 140. It is appreciated that blocks corresponding to additional or alternative functionality of other implementations described herein can be incorporated in method 140. For example, blocks corresponding to the functionality of various aspects of switch 114 otherwise described herein can be incorporated in method 140 even if such functionality is not explicitly characterized herein as a block in a method.

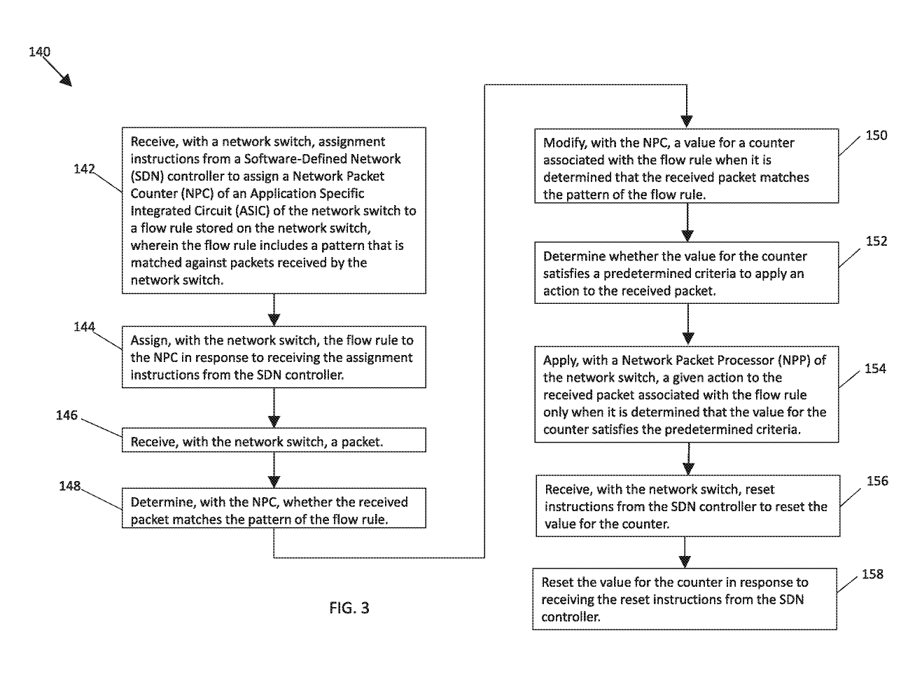

FIG. 3 illustrates another example of method 140 in accordance with the present disclosure. For illustration, FIG. 3 reproduces various blocks from method 140 of FIG. 2, however it is appreciated that method 140 of FIG. 3 can include additional, alternative, or fewer steps, functionality, etc., than method 140 of FIG. 2 and is not intended to be limited by the diagram of FIG. 2 (or vice versa) or the related disclosure thereof. It is further appreciated that method 140 of FIG. 2 can incorporate one or more aspects of method 140 of FIG. 3 and vice versa. For example, in some implementations, method 140 of FIG. 2 can include the additional step described below with respect to method 140 of FIG. 3.

Method 140 includes receiving (at block 156), with network switch 114, reset instructions from the SDN controller to reset the value for the counter. The reset instructions can, for example, be periodically transmitted to network switch 114 or can be transmitted to network switch 114 due to one or more network events or due to instructions by a network administrator or other entity.

Method 140 includes resetting (at block 158) the value for the counter in response to receiving the reset instructions by SDN controller 102. Certain implementations employing block 158 can allow the packet count to be restarted from SDN controller 102 without interrupting switch execution.

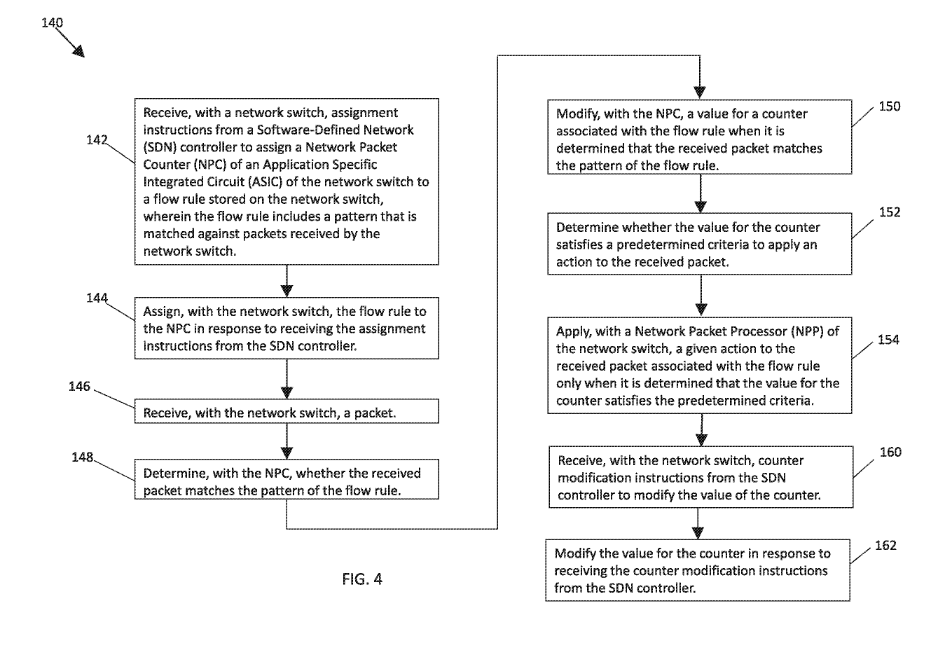

FIG. 4 illustrates another example of method 140 in accordance with the present disclosure. For illustration, FIG. 4 reproduces various blocks from method 140 of FIG. 2, however it is appreciated that method 140 of FIG. 4 can include additional, alternative, or fewer steps, functionality, etc., than method 140 of FIG. 2 and is not intended to be limited by the diagram of FIG. 2 (or vice versa) or the related disclosure thereof. It is further appreciated that method 140 of FIG. 2 can incorporate one or more aspects of method 140 of FIG. 4 and vice versa. For example, in some implementations, method 140 of FIG. 2 can include the additional step described below with respect to method 140 of FIG. 4.

Method 140 of FIG. 4 includes receiving (at block 160), with the network switch, counter modification instructions from the SDN controller to modify the value for the counter. Counter modification instructions can be periodically transmitted to network switch 114 or can be transmitted to network switch 114 due to one or more network events or due to instructions by a network administrator or other entity.

Method 140 of FIG. 4 includes modifying (at block 162) the value for the counter in response to receiving the counter modification instructions from the SDN controller. As described above with respect to FIG. 3, the counter modification instructions can, for example, include resetting the counter to zero or another reset value. Moreover, counter modification instructions can increase or decrease or otherwise modify the counter value to a desired value.

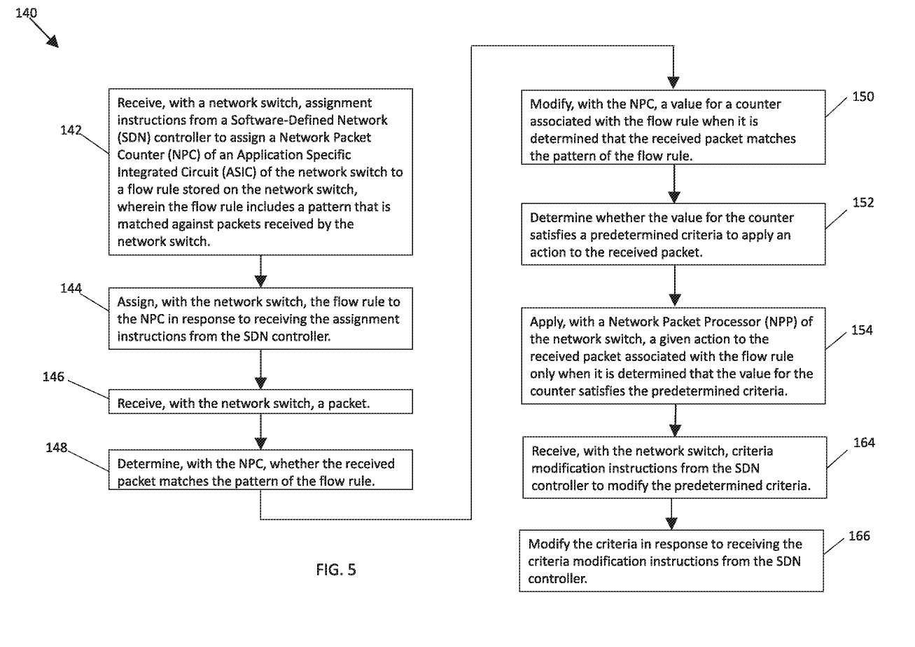

FIG. 5 illustrates another example of method 140 in accordance with the present disclosure. For illustration, FIG. 5 reproduces various blocks from method 140 of FIG. 2, however it is appreciated that method 140 of FIG. 5 can include additional, alternative, or fewer steps, functionality, etc., than method 140 of FIG. 2 and is not intended to be limited by the diagram of FIG. 2 (or vice versa) or the related disclosure thereof. It is further appreciated that method 140 of FIG. 2 can incorporate one or more aspects of method 140 of FIG. 5 and vice versa. For example, in some implementations, method 140 of FIG. 2 can include the additional step described below with respect to method 140 of FIG. 5.

Method 140 of FIG. 5 includes receiving (at block 164), with the network switch, criteria modification instructions from the SDN controller to modify the predetermined criteria. Criteria modification instructions can be periodically transmitted to network switch 114 or can be transmitted to network switch 114 due to one or more network events or due to instructions by a network administrator or other entity.

Method 140 of FIG. 5 includes modifying (at block 166) the criteria in response to receiving the criteria modification instructions from the SDN controller. The criteria modification instructions can, for example, include modifying the criteria to allow network switch 114 to receive more packets before applying an action. For example, if an initial criteria is satisfied when five matching packets are received by network switch 114, the modified criteria can be satisfied when 10 matching packets are received by network switch 114. It is appreciated that a quality of criteria can be modified instead of or in addition to a quantity of criteria. For example, criteria modification instructions can include instructions to modify criteria such that a different flow rule is assigned to the NPC, a different threshold value is used, and another condition, such as a minimum time duration, is applied.

FIG. 6 is a diagram of a network switch 114 in accordance with the present disclosure. As described in further detail below, network switch 114 includes an ASIC 168 including a NPC 170, a processing resource 172 and a memory resource 174 that stores machine-readable instructions 176, 178, and 180. For illustration, the description of network switch 114 of FIG. 6 makes reference to various aspects of method 140 of FIGS. 2-5 (such as the ASIC described above with respect to FIG. 2). Indeed, for consistency, the same reference number for the network switch of FIG. 1 is used for the network switch of FIG. 6. However it is appreciated that network switch 114 of FIG. 6 can include additional, alternative, or fewer aspects, functionality, etc., than the implementation described with respect to method 140 as well as the network switch of FIG. 1 and is not intended to be limited by the related disclosure thereof.

Instructions 176 stored on memory resource 174 are, when executed by processing resource 172, to cause processing resource 172 to assign, in accordance with instructions received by SDN controller 102, a packet flow rule for certain packets received by network switch to NPC of an ASIC of network switch 114. Instructions 176 can incorporate one or more aspects of blocks of method 140 or another suitable aspect of other implementations described herein (and vice versa). As but one example, in some implementations, instructions 176 can cause processing resource 172 to assign the NPC to a flow rule indicating that any packet received through ingress port A are to be forwarded to egress port C.

Instructions 178 stored on memory resource 174 are, when executed by processing resource 172, to cause processing resource 172 to modify, with the NPC, a value for a counter associated with the given packet flow rule for received packets that match the pattern of the given packet flow rule. Instructions 178 can incorporate one or more aspects of blocks of method 140 or another suitable aspect of other implementations described herein (and vice versa). As but one example, in some implementations, instructions 178 can cause processing resource 172 to modify the value for the counter by incrementing the value for the counter.

Instructions 180 stored on memory resource 174 are, when executed by processing resource 172, to cause processing resource 172 to apply an action to the received packet in accordance with the flow rule only when the value for the counter is less than a threshold value. Instructions 180 can incorporate one or more aspects of blocks of method 140 or another suitable aspect of other implementations described herein (and vice versa). As but one example, in some implementations, instructions 180 can cause processing resource 172 to apply a series of given actions to the packet.

Processing resource 172 of network switch 114 can, for example, be in the form of a central processing unit (CPU), a semiconductor-based microprocessor, a digital signal processor (DSP) such as a digital image processing unit, other hardware devices or processing elements suitable to retrieve and execute instructions stored in memory resource 174, or suitable combinations thereof. Processing resource 172 can, for example, include single or multiple cores on a chip, multiple cores across multiple chips, multiple cores across multiple devices, or suitable combinations thereof. Processing resource 172 can be functional to fetch, decode, and execute instructions as described herein. As an alternative or in addition to retrieving and executing instructions, processing resource 172 can, for example, include at least one integrated circuit (IC), other control logic, other electronic circuits, or suitable combination thereof that include a number of electronic components for performing the functionality of instructions stored on memory resource 174. The term “logic” can, in some implementations, be an alternative or additional processing resource to perform a particular action and/or function, etc., described herein, which includes hardware, e.g., various forms of transistor logic, application specific integrated circuits (ASICs), etc., as opposed to machine executable instructions, e.g., software firmware, etc., stored in memory and executable by a processor. Processing resource 172 can, for example, be implemented across multiple processing units and instructions may be implemented by different processing units in different areas of network switch 114.

Memory resource 174 of network switch 114 can, for example, be in the form of a non-transitory machine-readable storage medium, such as a suitable electronic, magnetic, optical, or other physical storage apparatus to contain or store information such as machine-readable instructions 176, 178, and 180. Such instructions can be operative to perform one or more functions described herein, such as those described herein with respect to method 140 or other methods described herein. Memory resource 174 can, for example, be housed within the same housing as processing resource 172 for network switch 114, such as within a computing tower case for network switch 114. In some implementations, memory resource 174 and processing resource 172 are housed in different housings. As used herein, the term “machine-readable storage medium” can, for example, include Random Access Memory (RAM), flash memory, a storage drive (e.g., a hard disk), any type of storage disc (e.g., a Compact Disc Read Only Memory (CD-ROM), any other type of compact disc, a DVD, etc.), and the like, or a combination thereof. In some implementations, memory resource 174 can correspond to a memory including a main memory, such as a Random Access Memory (RAM), where software may reside during runtime, and a secondary memory. The secondary memory can, for example, include a nonvolatile memory where a copy of machine-readable instructions are stored. It is appreciated that both machine-readable instructions as well as related data can be stored on memory mediums and that multiple mediums can be treated as a single medium for purposes of description.

ASIC 168 and memory resource 174 can be in communication with processing resource 172 via respective communication links 182. Each communication link 182 can be local or remote to a machine (e.g., a computing device) associated with processing resource 172. Examples of a local communication link 182 can include an electronic bus internal to a machine (e.g., a computing device) where memory resource 174 is one of volatile, non-volatile, fixed, and/or removable storage medium in communication with processing resource 172 via the electronic bus.

In some implementations, one or more aspects of network switch 114 and SDN controller 102 can be in the form of functional modules that can, for example, be operative to execute one or more processes of instructions 176, 178, or 180 or other functions described herein relating to other implementations of the disclosure. As used herein, the term “module” refers to a combination of hardware (e.g., a processor such as an integrated circuit or other circuitry) and software (e.g., machine- or processor-executable instructions, commands, or code such as firmware, programming, or object code). A combination of hardware and software can include hardware only (i.e., a hardware element with no software elements), software hosted at hardware (e.g., software that is stored at a memory and executed or interpreted at a processor), or hardware and software hosted at hardware. It is further appreciated that the term “module” is additionally intended to refer to one or more modules or a combination of modules. Each module of a network switch 114 can, for example, include one or more machine-readable storage mediums and one or more computer processors.

In view of the above, it is appreciated that the various instructions of network switch 114 described above can correspond to separate and/or combined functional modules. For example, instructions 176 can correspond to an “assignment module” to assign, in accordance with instructions received by SDN controller 102, a packet flow rule for certain packets received by the network switch to NPC 170, instructions 178 can correspond to a “modification module” to modify, with the NPC, a value for a counter associated with the given packet flow rule for received packets that match the pattern of the given packet flow rule, and instructions 180 can correspond to a “application module” to apply an action to the received packet in accordance with the flow rule only when the value for the counter is less than a threshold value. It is further appreciated that a given module can be used for multiple functions. As but one example, in some implementations, a single module can be used to both assign packet flow rules (corresponding to the functionality of instructions 176) as well as to modify the counter associated with the given packet flow rule (corresponding to the functionality of instructions 178). Likewise, as provided above with respect to FIG. 1, SDN controller 102 can include various modules corresponding to the various functions performed by SDN controller 102, such as: (1) assignment module 104 to determine and/or assign an NPC of an ASIC of network switch 114 to a flow rule stored on network switch; (2) reset module 106 to determine and/or transmit reset instructions to network switch 114 to reset the value for the counter of network switch 114; (3) counter modification module 108 to determine and/or transmit counter modification instructions to network switch 114 to modify the value for the counter of network switch 114; (4) criteria modification module 110 to determine and/or transmit criteria modification instructions to network switch 114 to modify the criteria for network switch 114; and (5) flow rule module 112 to determine and/or transmit flow rules to network switch 114.

One or more nodes within SDN 100 (e.g., SDN controller 102, network switch 114, etc.) can further include a suitable communication module to allow networked communication between SDN controller 102, network switch 114, and/or other elements of SDN 100. Such a communication module can, for example, include a network interface controller having an Ethernet port and/or a Fibre Channel port. In some implementations, such a communication module can include wired or wireless communication interface, and can, in some implementations, provide for virtual network ports. In some implementations, such a communication module includes hardware in the form of a hard drive, related firmware, and other software for allowing the hard drive to operatively communicate with other hardware of SDN controller 102, network switch 114, or other network equipment. The communication module can, for example, include machine-readable instructions for use with communication the communication module, such as firmware for implementing physical or virtual network ports.

FIG. 7 illustrates a machine-readable storage medium 184 including various instructions that can be executed by a computer processor or other processing resource. In some implementations, medium 184 can be housed within a network switch, such as a network switch 114, or on another computing device within SDN 100 or in local or remote wired or wireless data communication with SDN 100.

For illustration, the description of machine-readable storage medium 184 provided herein makes reference to various aspects of network switch 114 (e.g., processing resource 172) and other implementations of the disclosure (e.g., method 140). Although one or more aspects of network switch 114 (as well as instructions such as instructions 176, 178, and 180) can be applied or otherwise incorporated with medium 184, it is appreciated that in some implementations, medium 184 may be stored or housed separately from such a system. For example, in some implementations, medium 184 can be in the form of Random Access Memory (RAM), flash memory, a storage drive (e.g., a hard disk), any type of storage disc (e.g., a Compact Disc Read Only Memory (CD-ROM), any other type of compact disc, a DVD, etc.), and the like, or a combination thereof.

Medium 184 includes machine-readable instructions 186 stored thereon to cause processing resource 172 to assign a given packet flow rule to a given Network Packet Counter (NPC) of an Application Specific Integrated Circuit (ASIC) of a network switch. Instructions 186 can, for example, incorporate one or more aspects of block 144 of method 140 or instructions 176 of network switch 114 or another suitable aspect of other implementations described herein (and vice versa).

Medium 184 includes machine-readable instructions 188 stored thereon to cause processing resource 172 to determine, with the NPC, whether a packet received by the network switch matches a pattern of the given packet flow rule. Instructions 188 can, for example, incorporate one or more aspects of block 148 of method 140 or instructions 178 of network switch 114 or another suitable aspect of other implementations described herein (and vice versa).

Medium 184 includes machine-readable instructions 190 stored thereon to cause processing resource 172 to modify, with the NPC, a value for a counter associated with the given packet flow rule when it is determined that the received packet matches the pattern of the given packet flow rule. Instructions 190 can, for example, incorporate one or more aspects of block 150 of method 140 or instructions 178 of network switch 114 or another suitable aspect of other implementations described herein (and vice versa).

Medium 184 includes machine-readable instructions 192 stored thereon to cause processing resource 172 to apply an action to the received packet associated with the flow rule when the value for the counter satisfies the predetermined criteria. Instructions 192 can, for example, incorporate one or more aspects of block 154 of method 140 or instructions 180 of network switch 114 or another suitable aspect of other implementations described herein (and vice versa).

While certain implementations have been shown and described above, various changes in form and details may be made. For example, some features that have been described in relation to one implementation and/or process can be related to other implementations. In other words, processes, features, components, and/or properties described in relation to one implementation can be useful in other implementations. Furthermore, it should be appreciated that the systems and methods described herein can include various combinations and/or sub-combinations of the components and/or features of the different implementations described. Thus, features described with reference to one or more implementations can be combined with other implementations described herein.

As used herein, “logic” is an alternative or additional processing resource to perform a particular action and/or function, etc., described herein, which includes hardware, e.g., various forms of transistor logic, application specific integrated circuits (ASICs), etc., as opposed to machine executable instructions, e.g., software firmware, etc., stored in memory and executable by a processor. Further, as used herein, “a” or “a number of” something can refer to one or more such things. For example, “a number of widgets” can refer to one or more widgets. Also, as used herein, “a plurality of” something can refer to more than one of such things.

What is claimed is:

1. A method comprising:
receiving, with a network switch, assignment instructions from a Software-Defined Network (SDN) controller to assign a Network Packet Counter (NPC) of an Application Specific Integrated Circuit (ASIC) of the network switch to a flow rule stored on the network switch, wherein the flow rule includes a pattern that is matched against packets received by the network switch;
assigning, with the network switch, the flow rule to the NPC in response to receiving the assignment instructions from the SDN controller;
receiving, with the network switch, a packet;
determining, with the NPC, whether the received packet matches the pattern of the flow rule;
modifying, with the NPC, a value for a counter associated with the flow rule when it is determined that the received packet matches the pattern of the flow rule;
determining whether the value for the counter satisfies a predetermined criteria to apply an action to the received packet; and
applying, with a Network Packet Processor (NPP) of the network switch, a given action to the received packet associated with the flow rule only when it is determined that the value for the counter satisfies the predetermined criteria.

2. The method of claim 1, wherein applying, with the NPP, a given action to the packet includes applying a series of given actions to the packet.

3. The method of claim 1, wherein the action applied is to send the received packet to a given port of the network switch.

4. The method of claim 1, wherein the action applied is to modify the received packet.

5. The method of claim 1, wherein the action applied is to create a copy of the received packet.

6. The method of claim 1, wherein an alternative action is applied to the received packet when it is determined that the value for the counter does not satisfy the predetermined criteria.

7. The method of claim 1, wherein the predetermined criteria is satisfied when the value for the counter is less than a threshold value and the predetermined criteria is not satisfied when the value for the counter is equal to or exceeds a threshold value.

8. The method of claim 1, wherein modifying the value for the counter includes incrementing the value for the counter.

9. The method of claim 1, further comprising:
receiving, with the network switch, reset instructions from the SDN controller to reset the value for the counter; and
resetting the value for the counter in response to receiving the reset instructions from the SDN controller.

10. The method of claim 1, further comprising:
receiving, with the network switch, counter modification instructions from the SDN controller to modify the value for the counter; and
modifying the value for the counter in response to receiving the counter modification instructions from the SDN controller.

11. The method of claim 1, further comprising:
receiving, with the network switch, criteria modification instructions from the SDN controller to modify the predetermined criteria; and
modifying the criteria in response to receiving the criteria modification instructions from the SDN controller.

12. A non-transitory machine readable storage medium having stored thereon machine readable instructions to cause a computer processor to:
assign a given packet flow rule to a given Network Packet Counter (NPC) of an Application Specific Integrated Circuit (ASIC) of a network switch;
determine, with the NPC, whether a packet received by the network switch matches a pattern of the given packet flow rule;
modify, with the NPC, a value for a counter associated with the given packet flow rule when it is determined that the received packet matches the pattern of the given packet flow rule; and
apply an action to the received packet associated with the flow rule when the value for the counter satisfies the predetermined criteria.

13. The medium of claim 12, wherein the medium is stored on the network switch connected to the SDN controller via a network connection.

14. A network switch comprising:
an Application-Specific Integrated Circuit (ASIC) including a Network Packet Counter (NPC);
a processing resource; and
a memory resource storing machine readable instructions to cause the processing resource to:
assign, in accordance with instructions received by a Software-Defined Network (SDN) controller, a packet flow rule for certain packets received by the network switch to the NPC;
modify, with the NPC, a value for a counter associated with the given packet flow rule for received packets that match the pattern of the given packet flow rule; and
apply an action to the received packet in accordance with the flow rule only when the value for the counter is less than a threshold value.

15. The network switch of claim 14, wherein the given packet flow rule is to be provided to the network switch via the SDN controller.
